(19) United States
(12) Patent Application Publication
(10) Pub. No.: US 2009/0195714 A1
(43) Pub. Date: Aug. 6, 2009

(54) COLOR SWITCHING DEVICE

(75) Inventor: June-Jei HUANG, Taoyuan Hsien (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan Hsien (TW)

(21) Appl. No.: 12/358,071

(22) Filed: Jan. 22, 2009

(30) Foreign Application Priority Data
Feb. 5, 2008 (TW) 097104526

(51) Int. Cl. G02F 1/23; G02F 1/133

(52) U.S. Cl. 349/9; 359/265

(57) ABSTRACT

A liquid crystal color switching device for use in a non-polarization projection device is disclosed. The color switching device comprises a PBS and two switchable phase retarder assemblies, respectively disposed at two outlets of the PBS, wherein each of the switchable phase retarder assemblies comprises at least one liquid crystal layer and at least one dichroic coating layer. When a white light with S- and P-polarizations enters the inlet of the PBS, the white light will be divided into two orthogonal polarized lights and emitted from two outlets of the PBS. After being modulated respectively by the switchable phase retarder assemblies of the two outlets, the two switched polarized lights will be combined by the PBS into a non-polarized light and be emitted from a third outlet of the PBS.

This application claims priority to Taiwan Patent Application No. 097104526 filed on Feb. 5, 2008; the disclosures of which are incorporated herein by reference in their entirety.

### BACKGROUND OF THE INVENTION

### Field of the Invention

The present invention provides a color switching device. In particular, the color switching device is non-polarized and for use in a display apparatus.

Currently, in common digital light processing (DLP) projection devices, color wheels are typically used to split white light into lights of different colors traveling along the designated light paths respectively. Generally, the color wheel is a disc that is primarily assembled by several color segments, such as a red, a green, and a blue color filter. The color wheel is rotated by a motor at a high speed to split the white light into lights of different colors rapidly. Setting the color wheel at a high rotational speed not only allows for rapid light splitting modulation, but may also reduce the “spoke time” to prevent color from breaking. The “spoke time” refers to a period of time needed to transit from one color segment of the color wheel to another. However, restricted by its mechanical nature, the rotational speed of the color wheel has a limit, so it is still difficult to completely eliminate the aforesaid color breaking phenomenon. In addition, there are typically stricter requirements for the imaging quality for projection devices which require a higher imaging quality, such as those used in home theaters. Moreover, when the rotational speed of the color wheel is increased, ensuing problems, such as mechanical abrasion, noise or vibrations accompanied with a high rotational speed, should also be taken into consideration.

In view of this, a color switching technology intended to replace the color wheel has emerged gradually over recent years. More specifically, this technology utilizes a liquid crystal color switch (LCCS) in conjunction with a plurality of color switching elements such as dichroic mirrors and retarder stacks to replace the conventional color wheel for light splitting modulation. FIG. 1 illustrates a projection device with a liquid crystal on silicon (LCOS) panel disclosed in U.S. Pat. No. 7,195,356. The most prominent difference between such an LCOS projection device and a DLP projection device is that the color switching device 10 of the LCOS projection device must work with a polarized light, while the DLP projection device must work with a non-polarized light. In more detail, the color switching device 10 comprises a plurality of color selective filter elements 11, a polarizing beam splitter (PBS) 12, a plurality of colored light liquid crystal (LC) layers 131, 132, 133, a plurality of reflective elements 14 and a phase retarder stack 15. The color switching device 10 is configured to split a polarized light according to the polarization directions thereof into a transmissive colored light and a reflective colored light orthogonal to each other. Furthermore, by driving predetermined liquid crystal layers 13, the color switching device 10 may further control whether or not to allow light of different colors to exit the color switching device 10 and impinge on the LCOS panel 16 for image processing purposes.

More specifically, when light emitted from a light source 1 travels through a plurality of optical elements in sequence, a white light with an S-polarization direction will be generated. The polarized light then travels into the color selective filter element 11 which, in this embodiment, acts as a filter element to separate the red colored light and the cyan colored light (the cyan colored light is a synthetic light combination of green and blue colored light). Consequently, after the polarized light passing through the color selective filter element 11, the polarized light would be modulated into a red colored polarized light with a P-polarization direction and a cyan colored light still with the S-polarization direction. Subsequently, after the red colored P-polarized light impinging on and transmits through the PBS 12, it will arrive at the red colored liquid crystal layer 131. The cyan colored S-polarized light entering the PBS 12 would be orthogonally to the red colored P-polarized light and be reflected therefrom, and then travels into the phase retarder stack 15 as well as the blue and green LC layers 132, 133 respectively.

For acting as switchable phase retarders, the red colored LC layer 131, the blue colored LC layer 132 and the green colored LC layer 133 are made of a ferroelectric liquid crystal material. Specifically, with the red colored LC layer 131 as an example, when being applied with a voltage, the red colored LC layer 131 provides a phase retardation of a quarter of wavelength along the 45° direction for a red colored light transmitted therethrough. Likewise, the blue and the green LC layers 132, 133 function in similar principles. Hence, as described above, after having traveled through the red colored LC layer 131 twice due to reflection by the reflective element 14, the polarization direction of the red colored light will be modulated from the P-polarization direction into the S-polarization direction and thus be reflected outwards from the PBS 12 a second time. Likewise, with the proper arrangement for the phase retarder stack 15 with the blue and the green colored LC layers 132, 133 and the reflective element 14, the cyan colored S-polarized light in the other direction would be modulated into a cyan colored P-polarized light and thus, is transmitted through the PBS 12 a second time. After the red colored S-polarized light reflected by the PBS 12 travels through the filter element 11, it is modulated into a P-polarized red colored light again, which is then, in addition with the cyan colored P-polarized light, sent to the LCOS substrate 16 for subsequent image processing.

In summary, the aforesaid LCCS controls the switching of the colored light by either applying or not applying a voltage. Compared to the mechanical color wheel mechanism, the LC type color switching device may achieve a higher color switching speed due to the fast transition of voltage signals. Unfortunately, such an optical system can only be used with polarized light and is not applicable to conventional DLP projection devices working with non-polarized light. Moreover, because such an optical system must be used in conjunction with particular optical elements such as color selective filter elements and a phase retarder stack, the design is rather complex, which makes it impractical to apply over a wide variety of projection devices.

To accomplish a more rapid color switching process, it is important to provide a new kind of color switching device for use in a conventional DLP projection device using non-polarized light to replace the conventional mechanical color wheel.

### SUMMARY OF THE INVENTION

One objective of this invention is to provide a color switching device for use in a projection device. The color switching device, which is adapted for use in an optical system working with a non-polarized light, is able to switch among the different colored lights rapidly, thus overcoming the shortcomings of the conventional mechanical color wheel, such as, color breaking, mechanical abrasion and vibration noise.

The projection device, which uses the color switching device of this invention, comprises a light source for providing a non-polarized input light along the first direction. The color switching device of this invention comprises a polarizing device, a first switchable phase retarder assembly and a second switchable phase retarder assembly. The polarizing device is adapted to polarize and divide the non-polarized input light into a first split and a second split, in which the first split comprises the first polarization direction and the second split comprises the second polarization direction. The first switchable phase retarder assembly is adapted to receive the first split and selectively modulate the first split into at least one colored light with the second polarization direction. The second switchable phase retarder assembly is adapted to receive the second split and selectively modulate the second split into at least one colored light with the first polarization direction synchronous with the first switchable phase retarder assembly. The at least one colored light with the second polarization direction and the at least one colored light with the first polarization direction are synchronously emitted back to the polarizing device by the first switchable phase retarder assembly and the second switchable phase retarder assembly, and then coupled by the polarizing device to become a single non-polarized output light emitting outwards along a second direction. Alternatively, the non-polarized input light is blocked by the polarizing device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional projection device of the prior art;

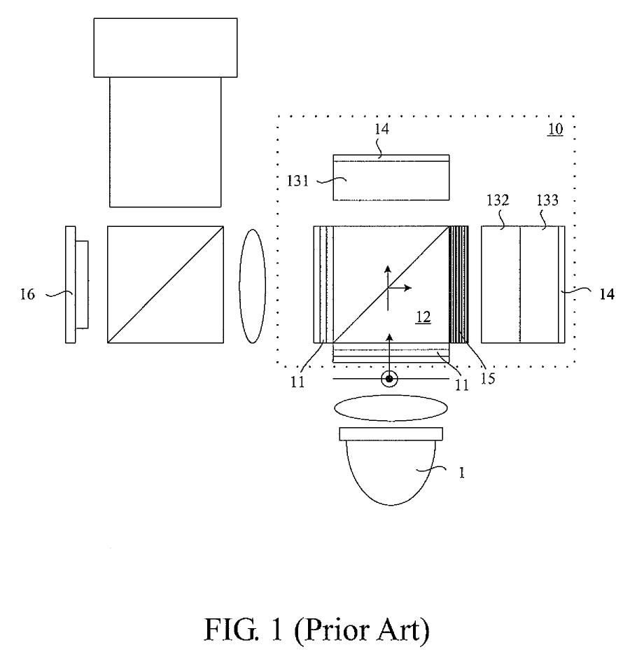

FIG. 2 is a schematic view of an embodiment of a projection device using a color switching device of this invention; and

FIG. 3 is a schematic view of a color switching device in accordance with an embodiment of this invention.

### DETAILED DESCRIPTION

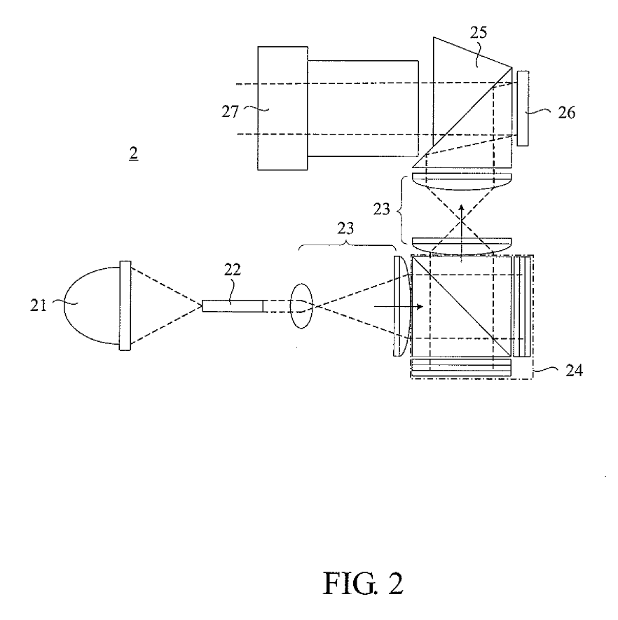

FIG. 2 illustrates a schematic view of an embodiment of a projection device using a color switching device of this invention. The projection device 2 utilizing the color switching device of this invention is a non-polarization projection device, and particularly a DLP projection device. The projection device 2 depicted herein comprises a light source 21, a light integration rod 22, a lens assembly 23, a color switching device 24, a total internal reflection (TIR) prism assembly 2S, a digital micromirror device (DMD) 26 and a projection lens assembly 27, in which the light source 21 provides a non-polarized input white light L_{IN}. It should be noted that all members of the projection device 2 depicted in FIG. 2 other than the color switching device 24 of this invention are identical to those of the prior art, so the optical structure of the projection device 2 is only for purposes of illustration rather than limitation.

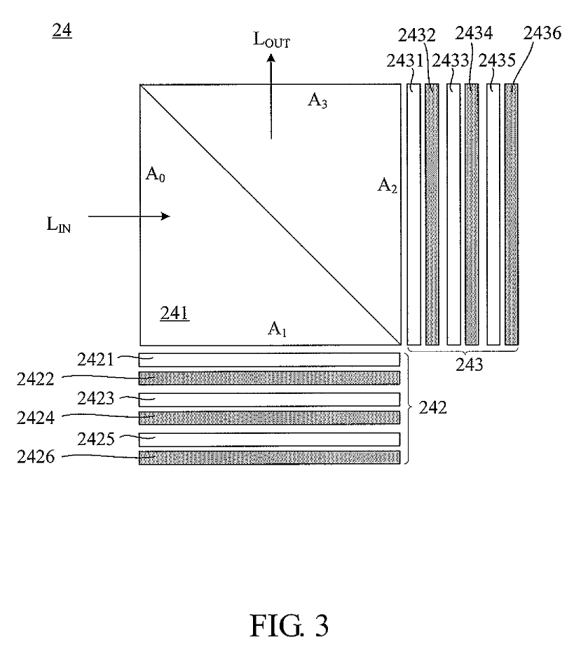

FIG. 3 illustrates a schematic view of the color switching device 24 in accordance with an embodiment of this invention. This invention is characterized in that the color switching device 24 acts as a source of colored light in the DLP projection device. In particular, the color switching device 24 of FIG. 3 comprises a polarizing device 241 and two switchable phase retarder assemblies 242, 243. In more detail, the polarizing device 241 is a polarizing beam splitter (PBS) device, which is selected form a group consisting of a PBS cube and a wire-grid PBS plate and combinations thereof. The polarizing device 241 generally has a plurality of inlets/outlets. For example, the polarizing device 241 in this embodiment has four inlets/outlets, among which an inlet A₀ is used to receive a white light L_{IN} from the light source 21. The two switchable phase retarder assemblies 242, 243 are disposed adjacent to two outlets A₁, A₂ of the polarizing device 241 respectively to receive and process lights exiting from the two outlets A₁, A₂.

Furthermore, a non-polarized input light from the light source 21 travels into the inlet A₀ of the polarizing device 241 along the first direction (not shown). Because of the polarizing effect of the polarizing device 241, the non-polarized input light is polarized and split into a first split and a second split substantially orthogonal to each other. The first split and the second split comprise light of three colors respectively, namely, a first colored light, a second colored light and a third colored light. The first split has a first polarization direction, while the second split has a second polarization direction. For example, the first colored light is a red colored light, the second colored light is a blue colored light, and the third colored light is a green colored light, although they are not merely limited thereto. In this embodiment, the first polarization direction is in the S-polarization direction, while the second polarization direction is in the P-polarization direction. Hence, the first split comprises a first, a second and a third colored light with the S-polarization direction, while the second split comprises a first, a second and a third light with the P-polarization direction.

When the non-polarized input light enters into the polarizing device 241, the first split with the S-polarization direction is reflected in the polarizing device 241 and exits from the first outlet A₁, while the second split with the P-polarization direction transmits through the polarizing device 241 directly and exits from the second outlet A₂. The first split and the second split exiting from the polarizing device 241 respectively then enter into the two switchable phase retarder assemblies 242, 243 disposed adjacent to the first outlet A₁ and the second outlet A₂.

The switchable phase retarder assembly disposed adjacent to the first outlet A₁ is the first switchable phase retarder assembly 242, and the assembly disposed adjacent to the second outlet A₂ is the second switchable phase retarder assembly 243. The first switchable phase retarder assembly 242 and the second switchable phase retarder assembly 243 operate in synchronism. The first switchable phase retarder assembly 242 is adapted to receive and selectively modulate the first split into at least one colored light with the second polarization direction. The second switchable phase retarder assembly 243 is adapted to receive and selectively modulate the second split into at least one colored light with the second polarization direction.

In particular, the first switchable phase retarder assembly 242 comprises a first switchable phase retarder 2421, a first color reflector 2422, a second switchable phase retarder 2423, a second color reflector 2424, a third switchable phase retarder 2425 and a third color reflector 2426 arranged in sequence from the first outlet A₁ outwards. Likewise, the second switchable phase retarder assembly 243 comprises a first switchable phase retarder 2431, a first color reflector 2432, a second switchable phase retarder 2433, a second color reflector 2434, a third switchable phase retarder 2435 and a third color reflector 2436 arranged in sequence from the second outlet A₂ outwards. The first color reflectors 2422, 2432 are adapted to reflect the first colored light, the second color reflectors 2424, 2434 are adapted to reflect the second colored light, and the third color reflectors 2426, 2436 are adapted to reflect the third colored light. Each of the switchable phase retarders 2421, 2431, 2423, 2433, 2425, 2435 substantially functions as a transparent glass that has no effect on any colored light when it does not act, and substantially functions as a quarter-wave plate when it acts.

In specific examples, each of the switchable phase retarders 2421, 2431, 2423, 2433, 2425, 2435 is selected from a group consisting of a pi-cell, ferroelectric liquid crystal (FLC), a Faraday rotator, a Pockels cell, a Kerr cell, and combinations thereof. The actions of the switchable phase retarders are controlled by applying a voltage. For example, in an FLC switchable phase retarder, when an appropriate voltage is applied to the FLC switchable phase retarder, the liquid crystal molecules in the FLC will be twisted to perform functions like those of a quarter-wave plate. In contrast, when not being applied with a voltage, the FLC switchable phase retarder merely functions like a transparent glass without any reaction from the liquid crystal molecules. Furthermore, each of the color reflectors 2422, 2432, 2424, 2434, 2426, 2436 may be, for example, a diachronic mirror.

As described above, by controlling of an appropriate voltage, the switchable phase retarders of the first switchable phase retarder assembly 242 and the second switchable phase retarder assembly 243 would selectively enable at least one colored light with the second polarization direction (i.e., the P-polarization direction) and at least one colored light with the first polarization direction (i.e., the S-polarization direction) to synchronously be emitted back to the polarizing device 241 from the first outlet A₁ and the second outlet A₂ respectively, and coupled by the polarizing device 241 into a non-polarized output light L_{OUT} which is emitted out along a second direction (not shown), i.e., a non-polarized output light is emitted out from the third outlet A₃. Alternatively, the polarizing device 241 may selectively block the non-polarized input light as described below in the operation mode No. 8, i.e., no light exits along the second direction, thus resulting in a full-black image in the projection lens assembly 27.

As shown in Table 1 below, when a voltage is selectively applied to each of the switchable phase retarders 2421, 2431, 2423, 2433, 2425, 2435 respectively, a red, blue, green, yellow, cyan, magenta colored light or white light is emitted out from the third outlet A₃, or a full-black state may result. In Table 1, “1” represents that a voltage is applied and “0” represents that no voltage is applied.

To explain the operation modes of the color switching device of this invention, various acting statuses of the switchable phase retarder assemblies listed in Table 1 will be described individually hereinbelow.

1. When a voltage is applied to the two first switchable phase retarders 2421, 2431 and the two second switchable phase retarders 2423, 2433 to cause action, a first colored light (i.e, a red colored light) with the S-polarization direction in the first split exiting from the first outlet A₁ experiences a phase retardation of a quarter wavelength due to the retarding effect of the switchable phase retarder 2421 and is then reflected by the first color reflector 2422 into the first switchable phase retarder 2421 again, where it then experiences a phase retardation of a quarter wavelength. As a result, the first colored light is modulated into the P-polarization direction. Likewise, a second colored light (i.e, a blue colored light) with the S-polarization direction in the first split exiting from the first outlet A₁ travels in sequence through the first and the second switchable phase retarders 2421, 2423, where it experiences a phase retardation of a half wavelength. Consequently, the second colored light is modulated into the P-polarization direction and is then reflected by the second color reflector 2424 into the second and the first switchable phase retarders 2423, 2421 again in sequence, where it is modulated back into the S-polarization direction again. Finally, in a similar way, since the third switchable phase retarder 2425 does not act, a third colored light (i.e., a green colored light) with the S-polarization direction in the first split exiting from the first outlet A₁ is modulated first into the P-polarization direction and then back into the S-polarization direction, just as described above for the second colored light with the S-polarization direction. Accordingly, the original first split is modulated into the first colored light with the P-polarization direction and the second and the third colored light both with the S-polarization direction, all of which are then reflected back into the first outlet A₁. Similarly, because the first, the second and the third switchable phase retarders 2431, 2433, 2435 of the second switchable phase retarder assembly 243 act synchronously with the first, second and third switchable phase retarders 2421, 2423, 2425 of the first switchable phase retarder assembly 242, the second split originally with the P-polarization direction is selectively modulated by the first, second and third switchable phase retarders 2431, 2433, 2435 as well as the first, second and third color reflectors 2432, 2434, 2436 into the first colored light with the S-polarization direction and the second and the third colored light both with the P-polarization direction, all of which are then reflected back into the second outlet A₂. At this point, the first colored light with the P-polarization direction in the first split and the first colored light with the S-polarization direction in the second split reflected inside the polarizing device 241 are coupled into a non-polarized first colored light in the second direction, and a first non-polarized output light (i.e., a non-polarized red colored light) is outputted from the third outlet A₃ in the second direction. Other colored light in the first split and the second split fails to be outputted from the third outlet A₃ due to the action of the polarizing device 241. Based on the working principles of the aforesaid elements, those skilled in the art will readily appreciate the following statuses obtained when a voltage is selectively applied to the first and the second switchable phase retarder assemblies 242, 243, which will be described briefly as follows.

2. When a voltage is applied to the two second switchable phase retarders 2423, 2433 and the two third switchable phase retarders 2425, 2435 to have them act, the second colored light (i.e., the blue colored light) with the P-polarization direction in the first split transmitted from the first outlet A₁ and the second colored light with the S-polarization direction in the second split transmitted from the second outlet A₂ are coupled by the polarizing device 241 into a second non-polarized output light (i.e., a non-polarized blue colored light).

3. When a voltage is applied to the two third switchable phase retarders 2425, 2435 to have them act, the third colored light (i.e., a green colored light) with the P-polarization direction in the first split transmitted from the first outlet A₁ and the third colored light with the S-polarization direction in the second split transmitted from the second outlet A₂ are coupled by the polarizing device 241 into a third non-polarized output light (i.e., a non-polarized green colored light).

4. When a voltage is applied to all of the switchable phase retarders 2421, 2431, 2423, 2433, 2425, 2435 to have them act, the first colored light (i.e., a red colored light) and the third colored light (i.e., a green colored light) with the P-polarization direction in the first split transmitted from the first outlet A₁ as well as the first colored light and the third colored light with the S-polarization direction in the second split transmitted from the second outlet A₂ are coupled by the polarizing device 241 into a fourth non-polarized output light (i.e., a non-polarized yellow colored light).

5. When a voltage is applied to the two second switchable phase retarders 2423, 2433 to have them act, the second colored light (i.e., a blue colored light) and the third colored light (i.e., a green colored light) with the P-polarization direction in the first split transmitted from the first outlet A₁ as well as the second colored light and the third colored light with the S-polarization direction in the second split transmitted from the second outlet A₂ are coupled by the polarizing device 241 into a fifth non-polarized output light (i.e., a non-polarized cyan colored light).

6. When a voltage is applied to the two first switchable phase retarders 2421, 2431 and the two third switchable phase retarders 2425, 2435 to have them act, the first colored light (i.e., a red colored light) and the second colored light (i.e., a blue colored light) with the P-polarization direction in the first split transmitted from the first outlet A₁ as well as the first colored light and the second colored light with the S-polarization direction in the second split transmitted from the second outlet A₂ are coupled by the polarizing device 241 into a sixth non-polarized output light (i.e., a non-polarized magenta colored light).

7. When a voltage is applied to the two first retarderswitchable phase retarders 2421, 2431 to have them act, the first colored light (i.e., a red colored light), the second colored light (i.e., a blue colored light) and a third colored light (i.e., a green colored light) with the P-polarization direction in the first split transmitted from the first outlet A₁ as well as the first colored light, the second colored light and the third colored light with the S-polarization direction in the second split transmitted from the second outlet A₂ are coupled by the polarizing device 241 into a seventh non-polarized output light (i.e., a non-polarized white light).

8. When no voltage is applied to any of the switchable phase retarders 2421, 2431, 2423, 2433, 2425, 2435, none of these switchable phase retarders will act. In this case, the first split transmitted from the first outlet A₁ back into the polarizing device 241 still contains light of three colors with the S-polarization direction; likewise, the second split transmitted from the second outlet A₂ back into the polarizing device 241 still contains light of three colors with the P-polarization direction. The effect of the polarizing effect 241 will make it impossible for the first split and the second split to exit from the third outlet A₃. Consequently, the non-polarized input light is substantially blocked by the polarizing device 241, resulting in a full-black image in the projection lens assembly 27.

The voltage signals applied to the switchable phase retarders may be switched in a rapid way. Hence, as compared to the conventional mechanical color wheel structure, the color switching device of this invention features a faster color switching process and can effectively prevent the color from breaking. Only the FLC is described as an example of the switchable phase retarder in the above description and Table 1, and those skilled in the art will recognize that other kinds of switchable phase retarders may be used to apply different control methods.

TABLE 1

| | Output light | | | | | | | |
|---|---|---|---|---|---|---|---|---|
| Voltage applied to | Red | Blue | Green | Yellow | Cyan | Magenta | White | Black |
| The first switchable | 1 | 0 | 0 | 1 | 0 | 1 | 1 | 0 |
| phase retarders 2421, | | | | | | | | |
| 2431 | | | | | | | | |
| The second switchable | 1 | 1 | 0 | 1 | 1 | 0 | 0 | 0 |
| phase retarders 2423, | | | | | | | | |
| 2433 | | | | | | | | |
| The third switchable | 0 | 1 | 1 | 1 | 0 | 1 | 0 | 0 |
| phase retarders 2425, | | | | | | | | |
| 2435 | | | | | | | | |

In summary, as compared to the aforesaid liquid crystal color switch which requires complex and special optical elements, the color switching device of this invention only necessitates the use of common optical elements, for example, PBSs, FLC switchable phase retarders and splitters. Therefore, the color switching device of this invention is more widely applicable. Moreover, the color switching device of this invention is adapted to work with non-polarized optical structures, so it helps to replace the conventional mechanical color wheel structure in the DLP projection device, thus preventing problems of mechanical abrasion and vibration noise that were common with the aforesaid color wheel mechanism. The color switching device of this invention allows the selection of a colored light as desired without being restricted by the arrangement of color segments on the color wheel. In this way, the problem of color breaking is effectively addressed with a result of an improved imaging quality of the projection device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A color switching device for use in a projection device, the projection device comprising a light source for providing a non-polarized input light along a first direction, the color switching device comprising:
a polarizing device, adapted to polarize and divide the non-polarized input light into a first split and a second split, the first split comprising a first polarization direction and the second split comprising a second polarization direction;
a first switchable phase retarder assembly, adapted to receive the first split, for selectively modulating the first split into at least one colored light having the second polarization direction; and
a second switchable phase retarder assembly, adapted to receive the second split, synchronously with the first switchable phase retarder assembly, for selectively modulating the second split into at least one colored light having the first polarization direction,
wherein the at least one colored light having the second polarization direction and the at least one colored light having the first polarization direction are synchronously emitted back to the polarizing device by the first switchable phase retarder assembly and the second switchable phase retarder assembly, and coupled into a non-polarized output light by the polarizing device which is emitted out along a second direction.

2. The color switching device of claim 1, wherein the polarizing device is a polarizing beam splitter (PBS).

3. The color switching device of claim 2, wherein the PBS is one of a PBS cube and a wire-grid PBS plate.

4. The color switching device of claim 1, wherein the polarizing device comprises an inlet, a first outlet, a second outlet, and a third outlet, the first split and the second split are emitted respectively from the first outlet and the second outlet after the polarizing device receives the non-polarized input light from the inlet, and the non-polarized output light is emitted from the third outlet.

5. The color switching device of claim 4, wherein the first switchable phase retarder assembly is disposed adjacent to the first outlet and the second switchable phase retarder assembly is disposed adjacent to the second outlet.

6. The color switching device of claim 1, wherein the first polarization direction is an S-polarization direction and the second polarization direction is a P-polarization direction, and after the non-polarized input light is received by the polarizing device, the first split with the S-polarization direction is reflected out of the polarizing device, the second split with the P-polarization direction is transmitted out of the polarizing device and is substantially orthogonal to the first split.

7. The color switching device of claim 6, wherein the first split with the S-polarization direction comprises a first colored light, a second colored light, and a third colored light with the S-polarization direction and the second split with the P-polarization direction comprises a first colored light, a second colored light, and a third colored light with the P-polarization direction.

8. The color switching device of claim 7, wherein each of the two switchable phase retarder assemblies comprises a first switchable phase retarder, a first color reflector, a second switchable phase retarder, a second color reflector, a third switchable phase retarder, and a third color reflector, which are spatially arranged in sequence, the first color reflector is adapted to reflect the first color, the second color reflector is adapted to reflect the second colored light, the third color reflector is adapted to reflect the third colored light, and wherein each of the switchable phase retarders functions as a transparent glass when each of the switchable phase retarders does not act, and each of the switchable phase retarders functions as a quarter-wave plate when each of the switchable phase retarders acts.

9. The color switching device of claim 8, wherein the polarizing device couples the first colored light with the P-polarization direction transmitted from the first switchable phase retarder assembly, and the first colored light with the S-polarization direction transmitted from the second switchable phase retarder assembly, into a first non-polarized output colored light when the two first switchable phase retarders and the two second switchable phase retarders act,
wherein the polarizing device couples the second colored light with the P-polarization direction transmitted from the first switchable phase retarder assembly and the second colored light with the S-polarization direction transmitted from the second switchable phase retarder assembly, into a second non-polarized output colored light, when the two second switchable phase retarders and the two third switchable phase retarders act, and
wherein the polarizing device couples the third colored light with the P-polarization direction transmitted from the first switchable phase retarder assembly and the third colored light with the S-polarization direction transmitted from the second switchable phase retarder assembly, into a third non-polarized output colored light when the two third switchable phase retarders act.

10. The color switching device of claim 9, wherein the non-polarized input light is a white light, the first non-polarized output colored light is a red colored light, the second non-polarized output colored light is a blue colored light, and the third non-polarized output colored light is a green colored light.

11. The color switching device of claim 8, wherein the polarizing device couples the first colored light and the third colored light with the P-polarization direction transmitted from the first switchable phase retarder assembly, and the first colored light and the third colored light with the S-polarization direction transmitted from the second switchable phase retarder assembly, into a fourth non-polarized output colored light when the two first switchable phase retarders, the two second switchable phase retarders and the two third switchable phase retarders all act,
wherein the polarizing device couples the second colored light and the third colored light with the P-polarization direction transmitted from the first switchable phase retarder assembly and the second colored light and the third colored light with the S-polarization direction transmitted from the second switchable phase retarder assembly, into a fifth non-polarized output color when the two second switchable phase retarders act, and
wherein the polarizing device couples the first colored light and the second colored light with the P-polarization direction transmitted from the first switchable phase retarder assembly and the first colored light and the second colored light with the S-polarization direction transmitted from the second switchable phase retarder assembly, into a sixth non-polarized output colored light when the two first switchable phase retarders and the two third switchable phase retarders act.

12. The color switching device of claim 11, wherein the non-polarized input light is white light, the fourth non-polarized output colored light is a yellow colored light, the fifth non-polarized output colored light is a cyan colored light, and the sixth non-polarized output colored light is a magenta colored light.

13. The color switching device of claim 8, wherein the polarizing device couples the first colored light, the second colored light, and the third colored light with the P-polarization direction transmitted from the first switchable phase retarder assembly, and the first colored light, the second colored light, and the third colored light with the S-polarization direction transmitted from the second switchable phase retarder assembly, into a seventh non-polarized output colored light when the two first switchable phase retarders act.

14. The color switching device of claim 13, wherein the non-polarized input light is white light, the seventh non-polarized output colored light is white light.

15. The color switching device of claim 8, wherein each of the first, the second, and the third switchable phase retarders is selected from a group consisting of a pi-cell, ferroelectric liquid crystal, a Faraday rotator, a Pockels cell, a Kerr cell and the combination thereof.

16. A color switching device for use in a projection device, the projection device comprising a light source for providing a non-polarized input light along a first direction, the color switching device comprising:
a polarizing device, adapted to polarize and divide the non-polarized input light into a first split and a second split, the first split comprising a first polarization direction and the second split comprising a second polarization direction;
a first switchable phase retarder assembly, adapted to receive the first split, for selectively modulating the first split into three colored lights having the first polarization direction; and
a second switchable phase retarder assembly, adapted to receive the second split, synchronously with the first switchable phase retarder assembly, for selectively modulating the second split into three colored lights having the second polarization direction,
wherein the three colored lights having the first polarization direction and the three colored lights having the second polarization direction are synchronously emitted back to the polarizing device by the first switchable phase retarder assembly and the second switchable phase retarder assembly, and the non-polarized input light are blocked from emitting out along a second direction by the polarizing device.

17. The color switching device of claim 16, wherein the polarizing device is a polarizing beam splitter (PBS).

18. The color switching device of claim 17, wherein the PBS is one of a PBS cube and a wire-grid PBS plate.

19. The color switching device of claim 16, wherein the polarizing device comprises an inlet, a first outlet, a second outlet, and a third outlet, the first split and the second split are emitted respectively from the first outlet and the second outlet after the polarizing device receives the non-polarized input light from the inlet, and the non-polarized output light is emitted from the third outlet.

20. The color switching device of claim 19, wherein the first switchable phase retarder assembly is disposed adjacent to the first outlet and the second switchable phase retarder assembly is disposed adjacent to the second outlet.

21. The color switching device of claim 16, wherein the first polarization direction is an S-polarization direction and the second polarization direction is a P-polarization direction, and after the non-polarized input light is received by the polarizing device, the first split with the S-polarization direction is reflected out of the polarizing device, the second split with the P-polarization direction is transmitted out of the polarizing device and is substantially orthogonal to the first split.

22. The color switching device of claim 21, wherein the first split with the S-polarization direction comprises a first colored light, a second colored light, and a third colored light with the S-polarization direction and the second split with the P-polarization direction comprises a first colored light, a second colored light and a third colored light with the P-polarization direction.

23. The color switching device of claim 22, wherein each of the two switchable phase retarder assemblies comprises a first switchable phase retarder, a first color reflector, a second switchable phase retarder, a second color reflector, a third switchable phase retarder, and a third color reflector, which are spatially arranged in sequence, the first color reflector is adapted to reflect the first colored light, the second color reflector is adapted to reflect the second colored light, the third color reflector is adapted to reflect the third colored light, and wherein each of the switchable phase retarders functions as a transparent glass when each of the switchable phase retarders does not act, and each of the switchable phase retarders functions as a quarter-wave plate when each of the switchable phase retarders acts.

24. The color switching device of claim 23, wherein each of the first, the second, and the third switchable phase retarders is selected from a group consisting of a pi-cell, ferroelectric liquid crystal, a Faraday rotator, a Pockels cell, a Kerr cell and the combination thereof.
